(19) United States
(12) Patent Application Publication
(10) Pub. No.: US 2026/0261543 A1
(43) Pub. Date: Sep. 3, 2026

(54) METHODS, SYSTEMS, AND COMPUTER READABLE MEDIA FOR MEASURING INTERNET PROTOCOL (IP) ADDRESS ASSIGNMENT CONVERGENCE TIME OF A DEVICE UNDER TEST (DUT)

(71) Applicant: Keysight Technologies, Inc., Santa Rosa, CA (US)

(72) Inventors: Suryya Kumar Jana, Kolkata (IN); Kingshuk Mandal, Kolkata (IN)

(21) Appl. No.: 19/066,631

(22) Filed: Feb. 28, 2025

(51) Int. Cl. H04L 61/5014; H04L 43/50

(52) U.S. Cl. CPC H04L 61/5014; H04L 43/50

(57) ABSTRACT

A method for determining IP address assignment convergence time of a DUT includes operating, by a test tool, DHCP server. The method further includes receiving a request for IP address assignment. The method further includes reserving the IP address and transmitting the IP address to the DUT. The method further includes assigning the IP address to the DUT and recording a time value T1 associated with assigning the IP address to the DUT. The method further includes transmitting IP packets to the DUT and receiving one of the IP packets from the DUT. The method further includes recording, by the test tool, a time value T2 of receipt of the one IP packet. The method further includes calculating an IP address assignment convergence time of the DUT as a difference between T2 and T1 and displaying or otherwise communicating the IP address assignment convergence time of the DUT.

### TECHNICAL FIELD

The subject matter described herein relates to testing network devices. More particularly, the subject matter described herein relates to methods, systems, and computer readable media for measuring the IP address assignment convergence time of a device under test.

### BACKGROUND

The Internet protocol or IP is the dominant addressing scheme for devices connected to the public Internet. Internet Protocol version 4 is defined in Internet Engineering Task Force (IETF) Request for Comments (RFC) 791. IP version 4 uses 32 bit addresses to identify host devices for routing over networks. IP version 6 is defined in IETF RFC 2460 and use 64 bit addresses.

To be routable on a network that uses IP, a host must be assigned an IP address. One method for assigning IP addresses to hosts is static IP address assignment through manual configuration. However, manual IP address assignment is labor intensive and cumbersome for networks with large numbers of hosts and/or with a dynamically changing network topology.

To facilitate automated IP address assignment, the dynamic host configuration protocol (DHCP) was developed. DHCP is described in IETF RFC 2131 for IPv4 and IETF RFC 8415 for IPv6. A network administrator reserves a range or pool of IP addresses to be assigned using DHCP. This range or pool of IP addresses is configured with a DHCP server. A host seeking to obtain an IP address begins the process by broadcasting a DHCP DISCOVER message. A DHCP server or servers that receive the DHCP DISCOVER message respond with a DHCP OFFER message including the IP address that the DHCP server is offering, a subnet mask, a lease duration, and the IP address of the DHCP server sending the DHCP OFFER message. In response to the DHCP OFFER message, the host seeking to obtain the IP address responds with a DHCP REQUEST message requesting the offered address. The DHCP REQUEST message is a broadcast message that includes the IP address of the DHCP server that sent the DHCP OFFER message. The DHCP server that sent the DHCP OFFER message responds with a DHCP acknowledgment (ACK) message confirming assignment of the IP address to the requesting host and the lease duration for the IP address. The process of exchanging the DISCOVER, OFFER, REQUST, ACK messages for IP address assignment is referred to as the DORA process.

Once a host receives and configures itself to use a newly assigned an IP address, the host can begin processing IP traffic. For example, if the host is a router, the router can begin routing IP datagrams once the router’s interfaces have been assigned IP addresses. However, there can be a time delay between the time that an IP address is assigned by a DHCP server to the time that the host device to which the IP address has been assigned can start processing IP packets. The time delay is caused by the delay in the host receiving the IP address and configuring itself to begin using the IP address. Because a device must obtain an IP address each time the device attaches to the network or when an IP address lease expires, it is desirable to measure the delay between IP address assignment and processing of packets by the interface or interfaces to which IP addresses are assigned. The time between IP address assignment and processing of IP packets by an interface to which the IP address is assigned is referred to herein as the IP address assignment convergence time. It is desirable to measure the IP address assignment convergence time so that device manufacturers can improve their products and network operators can improve the efficiency of their networks.

Accordingly, in light of these and other difficulties, there exists a need for methods, systems, and computer readable media for determining IP address assignment convergence time.

### SUMMARY

A method for determining IP address assignment convergence time of a DUT includes operating, by a test tool, as a DHCP server. The method further includes receiving, by the test tool and from the DUT, a request for IP address assignment. The method further includes reserving, by the test tool, an IP address to be assigned to the DUT. The method further includes transmitting, by the test tool and using DHCP, the IP address to the DUT. The method further includes assigning, by the test tool, the IP address to the DUT. The method further includes recording, by the test tool, a time value T1 associated with assigning the IP address to the DUT. The method further includes transmitting, by the test tool and to the DUT, a plurality of IP packets. The method further includes receiving, by the test tool and from the DUT, one of the IP packets. The method further includes recording, by the test tool, a time value T2 of receipt of the one IP packet. The method further includes calculating, by the test tool, an IP address assignment convergence time of the DUT as a difference between T2 and T1. The method further includes displaying or otherwise communicating, by the test tool, the IP address assignment convergence time of the DUT.

According to another aspect of the subject matter described herein, operating as a DHCP server includes operating a control plane engine on a first port of the test tool as the DHCP server.

According to another aspect of the subject matter described herein, receiving the request for IP address assignment includes receiving a DHCP DISCOVER message from the DUT.

According to another aspect of the subject matter described herein, transmitting the IP address to the DUT includes transmitting the IP address to the DUT in a DHCP OFFER message.

According to another aspect of the subject matter described herein, the method for determining the IP address assignment convergence time of a DUT includes receiving, from the DUT, a DHCP REQUEST message requesting assignment of the IP address and assigning the IP address to the DUT includes assigning the IP address to the DUT in response to the DHCP REQUEST message and transmitting a DHCP ACK message to the DUT confirming assignment of the IP address to the DUT.

According to another aspect of the subject matter described herein, recording the time value T1 associated with assigning the IP address to the DUT includes recording a time of transmitting the DHCP ACK message the DUT confirming assignment of the IP address to the DUT.

According to another aspect of the subject matter described herein, transmitting the plurality of IP packets to the DUT includes transmitting the IP packets from a data plane traffic engine operating on the first port of the test tool.

According to another aspect of the subject matter described herein, receiving one of the IP packets from the DUT includes receiving the one IP packet by a data plane traffic engine operating on a second port of the test tool and recording the time value T2 associated with receipt of the one IP packet includes recording the value T2 by the data plane traffic engine operating on the second port of the test tool.

According to another aspect of the subject matter described herein, the method for determining the IP address convergence time of the DUT includes subscribing, by the data plane traffic engine operating on the first port of the test tool and with the control plane engine, to be notified when the DHCP server assigns the IP address to the DUT, receiving, by the data plane traffic engine operating on the first port of the test tool, notification of assignment of the IP address to the DUT and wherein transmitting the IP packets to the DUT includes transmitting the IP packets to the DUT after receiving the notification.

According to another aspect of the subject matter described herein, the control plane engine operating on the first port of the test tool inserts the time value T1 in a payload of each of the IP packets transmitted to the DUT and wherein calculating the IP address assignment convergence time includes reading the time value T1 from the payload of the one IP packet.

According to another aspect of the subject matter described herein, a system for determining IP address assignment convergence time of a DUT is provided. The system includes a test tool including at least one processor and a memory. The system further includes a DHCP server executable by the at least one processor for receiving, from the DUT, a request for IP address assignment, reserving, an IP address to be assigned to the DUT, transmitting, using DHCP, the IP address to the DUT, assigning the IP address to the DUT, and recording a time value T1 associated with assigning the IP address to the DUT. The system further includes a traffic source endpoint implemented by the test tool for transmitting a plurality of IP packets to the DUT. The system further includes a traffic destination endpoint implemented by the test tool for receiving one of the IP packets from the DUT. The system further includes an IP address assignment convergence time calculation module implemented by the test tool for recording a time value T2 associated with receipt of the one IP packet, calculating an IP address assignment convergence time of the DUT a difference between T2 and T1, and displaying or otherwise communicating the IP address assignment convergence time of the DUT.

According to another aspect of the subject matter described herein, the test tool includes a control plane engine operating on a first port of the test tool and the DHCP server is implemented by the control plane engine.

According to another aspect of the subject matter described herein, the DHCP server is configured to transmit the IP address to the DUT in a DHCP OFFER message.

According to another aspect of the subject matter described herein, the DHCP server is configured to receive, from the DUT, a DHCP REQUEST message requesting assignment of the IP address, assign the IP address to the DUT in response to the DHCP REQUEST message and transmit a DHCP acknowledgement (ACK) message to the DUT confirming assignment of the IP address to the DUT.

According to another aspect of the subject matter described herein, the DHCP server is configured to record, as the time value T1, a time of transmitting the DHCP ACK message the DUT.

According to another aspect of the subject matter described herein, the test tool comprises a data plane traffic engine operating on the first port of the test tool, the data plane traffic engine operating on the first port of the test tool implements the traffic source endpoint and transmits the IP packets to the DUT.

According to another aspect of the subject matter described herein, the test tool includes a data plane traffic engine operating on a second port of the test tool that implements the traffic destination endpoint, receives the one IP packet, and records the time value T2.

According to another aspect of the subject matter described herein, the data plane traffic engine operating on the first port of the test tool is configured to subscribe with the control plane engine to be notified when the DHCP server assigns the IP address to the DUT, receive notification of assignment of the IP address to the DUT and transmit the IP packets to the DUT after receiving the notification.

According to another aspect of the subject matter described herein, the control plane engine operating on the first port of the test tool is configured to insert the time value T1 in a payload of each of the IP packets transmitted to the DUT and the IP address assignment convergence time calculation module is configured to calculate the IP address assignment convergence time by reading the time value T1 from the payload of the one IP packet.

According to another aspect of the subject matter described herein, a non-transitory computer readable medium having stored thereon executable instructions that when executed by a processor of a computer controls the computer to perform steps is provided. The steps include operating, by a test tool, as a DHCP server. The steps further include receiving, by the test tool and from a DUT, a request for IP address assignment. The steps further include reserving, by the test tool, an IP address to be assigned to the DUT. The steps further include transmitting, by the test tool and using DHCP, the IP address to the DUT. The steps further include assigning, by the test tool, the IP address to the DUT. The steps further include recording, by the test tool, a time value T1 associated with assigning the IP address to the DUT. The steps further include transmitting, by the test tool and to the DUT, a plurality of IP packets. The steps further include receiving, by the test tool and from the DUT, one of the IP packets. The steps further include recording, by the test tool, a time value T2 of receipt of the one IP packet. The steps further include calculating, by the test tool, an IP address assignment convergence time of the DUT a difference between T2 and T1. The steps further include displaying or otherwise communicating, by the test tool, the IP address assignment convergence time of the DUT.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a message flow diagram illustrating exemplary messages exchanged between a test device and a device under test (DUT) in determining IP address assignment convergence time;

FIG. 2 is a block diagram illustrating an exemplary architecture of a test tool for determining IP address assignment convergence time; and

FIG. 3 is a flow chart illustrating an exemplary process for determining IP address assignment convergence time.

### DETAILED DESCRIPTION

As the networking industry is a fast growing and evolving industry with different technologies, increasing numbers of IP-based devices are being plugged into the network. All these devices need IP addresses from a central DHCP server. Once an IP address is assigned to a device by using DHCP, it is desirable to determine how fast the DUT can start forwarding data traffic to other nodes in the network.

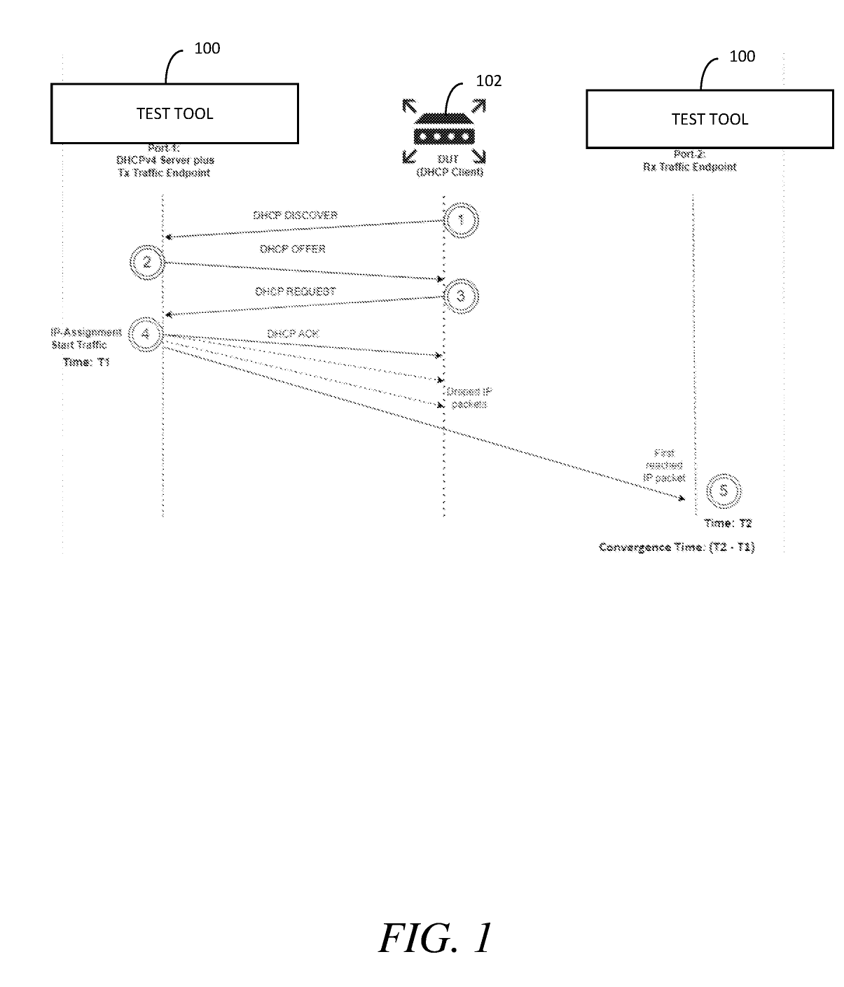

The subject matter described herein includes a methodology for IP assignment convergence time measurement for a DUT by a test tool. FIG. 1 is a message flow diagram illustrating exemplary messages exchanged between a test tool and DUT in determining IP address assignment convergence time. Referring to FIG. 1, a test tool 100 implements a DHCP server and a transmitting traffic endpoint on a first port (port 1) of test tool 100 and a receiving traffic endpoint on another port (port 2) of test tool 100. A DUT 102, which in the illustrated example, is a router, includes a DHCP client that requests an IP address using DHCP.

Referring to the message flow in FIG. 1, in step 1, the DHCP client of DUT 102 broadcasts a DHCP DISCOVER message. The DHCP server implemented on port 1 of test tool 100 receives the DHCP DISCOVER message and, in step 2, sends a DHCP OFFER message. The DHCP OFFER message includes a client Id (in one example, the medium access control (MAC) address of DUT 102), the IP address that the server is offering, the subnet mask, the lease duration, and the IP address of the DHCP server making the offer. In step 3, DUT 102 receives the DHCP OFFER message and responds by transmitting a DHCP REQUEST message. The DHCP REQUEST message is a broadcast message that includes the identifier of the DHCP server that made the offer. In step 4, the DHCP server executing on port 1 of test tool 100 sends a DHCP ACK message. At the time of transmission of the DHCP ACK message, test tool 100 records a timestamp T1 as the time of assignment of the IP address to DUT 102.

After transmitting the DHCP OFFER message, test tool 100 begins sending to DUT 102 IP packets addressed to the IP address associated with the receiving traffic endpoint implemented on port 2 of test tool 100. In the illustrated example, DUT 102 drops one or more of the packets, indicating that DUT 102 has not completed the process of assigning the IP address received from the DHCP server to one of the interfaces of DUT 102. Once DUT 102 completes the process of configuring itself to use the newly assigned IP address, one or more of the packets transmitted by the transmitting endpoint on port 1 of test tool 100 may reach the receiving traffic endpoint implemented on port 2 of test tool 100. When the receiving traffic endpoint of test tool 100 receives the first IP packet after assignment of the IP address to DUT 102, test tool 100 records the time of receipt of the packet as T2. Test tool 100 may then determine the IP address assignment convergence time as the difference between T2 and T1, e.g., by calculating T2 minus T1.

A test tool may include a control plane engine and a data plane traffic engine on each port. The control plane engine is responsible for executing the networking protocols used for communicating with the DUT. The data plane traffic engine is responsible for generating data traffic and transmitting the data traffic through the DUT by collecting learned protocol information from the control plane engine and using the learned protocol information to generate packets to send to the DUT. Using the learned protocol information, it becomes possible for the data plane traffic engine to send traffic to another endpoint on another port of the test tool through the DUT to verify that the DUT is ready to forward traffic. In one example, the test tool may implement the following three workflows:
1) Setup configure - pushes control plane and data-plane test configuration to the test tool;
2) Start protocol - starts the control plane; and
3) Start the traffic.

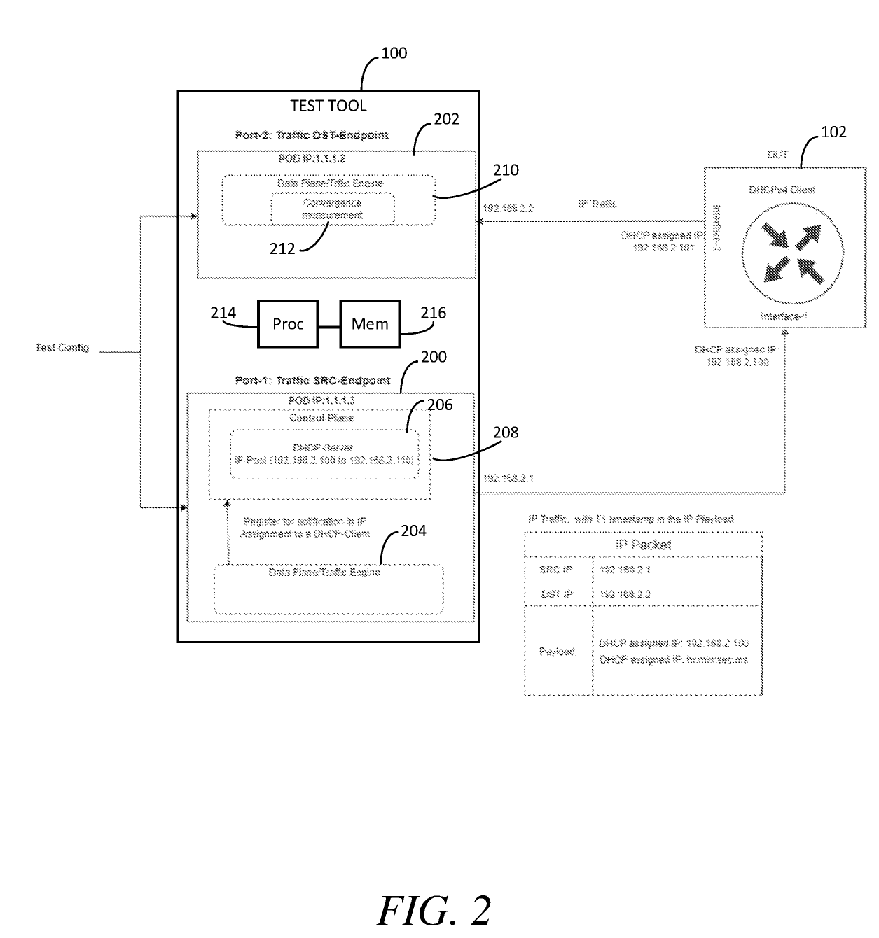

FIG. 2 is a block diagram illustrating exemplary components of test tool 100 for determining IP address assignment convergence time of a device under test. Referring to FIG. 2, test tool 100 includes a traffic source endpoint 200 and a traffic destination endpoint 202. Traffic source endpoint 200 includes a data plane traffic engine 204 that generates data plane traffic to be sent to device under test 102 after device under test 102 is assigned an IP address. Traffic source endpoint 200 further includes DHCP server 206, which is implemented by a control plane engine 208. Traffic destination endpoint 202 includes data plane traffic engine 210 that receives traffic from DUT 102. Data plane traffic engine 210 includes an IP address assignment convergence measurement module 212 for measuring IP address assignment convergence time as described herein. The components illustrated in FIG. 2 can be implemented using at least one processor 214 and memory 216. That is, traffic source endpoint 200 and its subcomponents as well as traffic destination endpoint 202 and its subcomponents can be implemented using computer executable instructions stored in memory 216 and executed by one or more processors 214.

In FIG. 2, DHCP server 206, control plane engine 208, and data plane traffic engine 204 execute on port 1 at a network interface which is assigned the IP address 192.168.2.1. Data plane traffic engine 210 executes on port 2 at a network interface which is assigned an IP address of 192.168.2.1. Two Interfaces of DUT 102 operate as DHCP clients needing IP address assignments. Interface 1 of DUT 102 is connected to port 1 of test tool 100, and interface 2 of DUT 102 is connected to port 2 of test tool 100. DHCP server 206 is configured with IP address pool (192.168.2.100 to 192.168.2.110) on port 1 of test tool 100. Data plane traffic engine 204 subscribes to control plane engine 208 for notifications of IP address assignments to DHCP clients. DUT 102 implements the DHCP DORA process for both of its interfaces and obtains IP addresses 192.168.2.100 and 192.168.2.101 from the DHCP server 206.

Control plane engine 208, during confirmation of the IP address assignment to DUT 102 using the DORA process, checks whether there are any subscriptions to be notified of the IP address assignment. Control plane engine 208 detects the subscription by data plane traffic engine 204 to be notified of IP address assignments and notifies data plane traffic engine 204 of the IP address assignment. The notification may include the assigned IP address 198.168.2.100 and a time value indicating the time that the IP address was assigned.

When data plane traffic engine 204 receives the notification of the IP address assignment from control plane engine 208, data plane traffic engine 204 generates a series of IP packets from the source IP address 192.168.2.1 to the destination IP address of 192.168.2.2. Data plane traffic engine 204 may insert in the payload of each of the IP packets the time value or timestamp of IP address assignment received from control plane engine 208.

DUT 102 may need some time to become ready before DUT 102 starts forwarding the IP traffic received from port 1 of test tool 100 on interface 1 of DUT 102 that to be forwarded to port 2 of test tool 100 through interface 2 of DUT 102. As a result, traffic statistics of on port 2 of DUT 102 may indicate that there is some traffic dropped by DUT 102 for a time period as compared to traffic statistics at port 1.

IP address assignment convergence time calculation module 212 on data plane traffic engine 210 running on port 2 of test tool 100 extracts the IP address and timestamp (T1) of the IP assignment and records the received the timestamp of the IP packet as T2. If the IP packet is the first successfully forwarded IP packet by DUT 102 for the extracted IP address, IP address assignment convergence time calculation module 212 calculates (T2 – T1) as the IP address assignment convergence time.

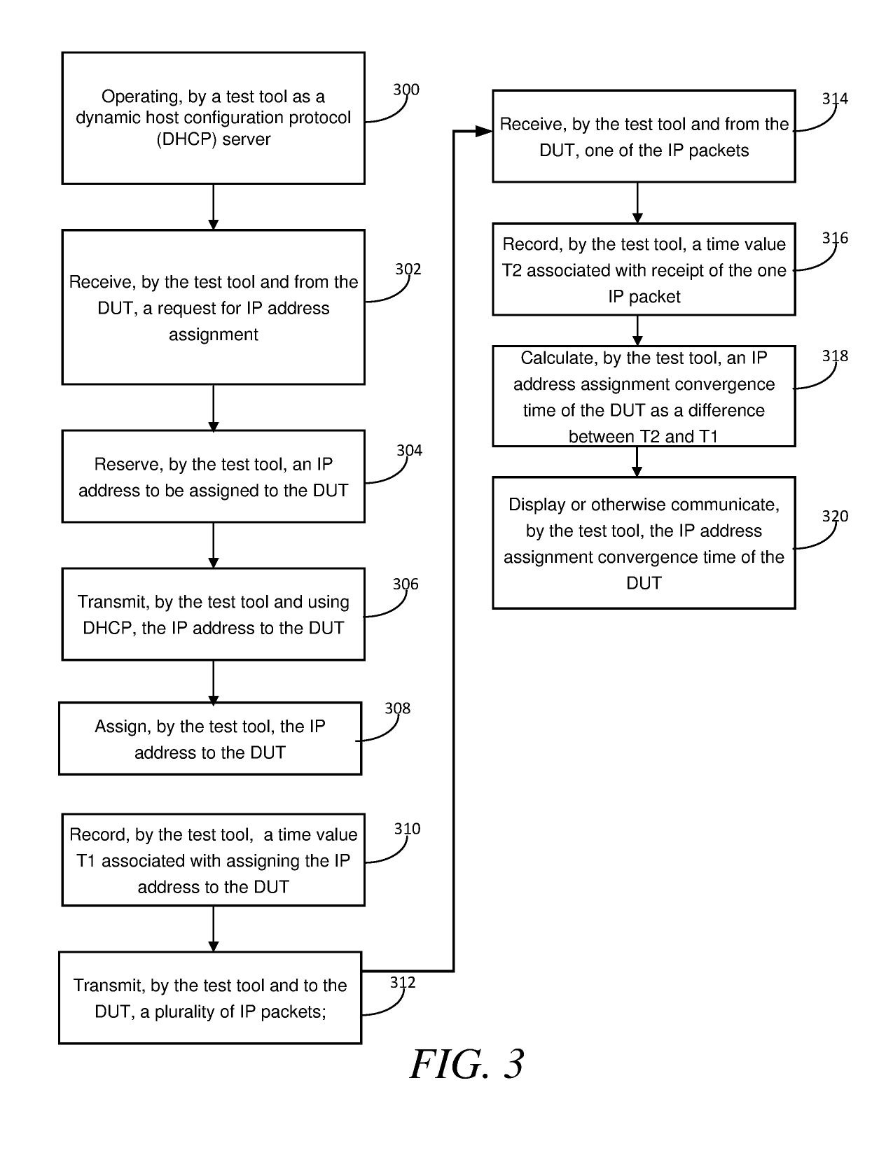

FIG. 3 is a flow chart illustrating an exemplary process for determining IP address assignment convergence time of a DUT. Referring to FIG. 3, in step 300, the process includes operating, by a test tool, as a DHCP server. For example, a network test tool that include one or more packet generation engines for testing network devices under test, such as switches, routers, firewalls, network address translators, clients, and servers, may include application software that implements at least the IP address assignment message exchanges of a DHCP server. Operating as a DHCP server can include operating a DHCP server for assigning IPv4 and/or IPv6 addresses to devices under test.

In step 302, the process further includes receiving, by the test tool and from the DUT, a request for IP address assignment. For example, a test tool, such as test tool 100, may receive a DHCP DISCOVER message broadcast by a DUT to request assignment of an IP address.

In step 304, the process further includes reserving, by the test tool, an IP address to be assigned to the DUT. For example, a test tool, such as test tool 100 may be provisioned with a pool of IP addresses for IP address assignment and may reserve one of the addresses in the pool in response to receiving the DHCP DISCOVER message.

In step 306, the process further includes transmitting, by the test tool and using DHCP, the IP address to the DUT. For example, a test tool, such as test tool 100 may offer an IP address to a DUT by transmitting a DHCP OFFER message, including the reserved IP address, to the DUT.

In step 308, the process includes assigning, by the test tool, the IP address to the DUT. For example, a test tool, such as test tool 100, may receive, from the DUT, a DHCP REQUEST message requesting assignment to the DUT of the IP address offered in the DHCP OFFER message. In response to receiving the DHCP REQUEST message, the test tool may assign the IP address to the DUT and notify the DUT of acceptance of the request for IP address assignment by transmitting a DHCP ACK message to the DUT.

In step 310, the process includes recording, by the test tool, a time value T1 of assigning the IP address to the DUT. For example, a test tool, such as test tool 100, may record the time value T1 of transmitting the DHCP ACK message to the DUT.

In step 312, the process includes transmitting, by the test tool and to the DUT, a plurality of IP packets. For example, a test tool, such as test tool 100, may transmit, to the DUT, IP packets from a first port of the test tool that are addressed to the IP address of a second port of the test tool. If the DUT is a router, and the DUT is ready to forward packets, the DUT will forward the packets to the second port of the test tool. The test tool may include, in the payload of each of the IP packets, the time value T1.

In step 314, the process further includes receiving, by the test tool and from the DUT, one of the IP packets. For example, a receive port of a test tool, such as test tool 100, may receive an IP packet transmitted by a transmit port of the test tool through the DUT. The packet may be the first packet that is successfully forward by the DUT after the IP address assignment. The first IP packet that is successfully received by the test tool may not be the first IP packet that is transmitted by the test tool after the IP address assignment, as some of the IP packets may be dropped by the DUT while the DUT is configuring itself to use the newly assigned IP address.

In step 316, the process further includes recording, by the test tool, a time value T2 associated with receipt of the one IP packet. For example, a test tool, such as test tool 100, may record a timestamp value when a first of the IP packets transmitted in step 312 is successfully received by the test tool.

In step 318, the process further includes calculating, by the test tool, an IP address assignment convergence time of the DUT as a difference between T2 and T1. For example, a test tool, such as test tool 100, may read the value T1 from the payload of the IP packet received in step 316 and calculate the difference between the time value T1 and the receipt timestamp value T2; e.g., the difference may be calculated as T2 minus T1.

In step 320, the process further includes displaying or otherwise communicating, by the test tool, the IP address assignment convergence time of the DUT. For example, a test tool, such as test tool 100, may display, via a graphical user interface, the IP address assignment convergence time of DUT 102. In another example, the test tool may communicate the IP address assignment convergence time to a test administrator user interface on a computing platform separate from that of test tool 100.

### Importance/Advantages

In modern networks topology changes frequently and rapid recovery from failures is important, network operators are interested in measuring network start up and recovery delays. IP address assignment convergence delay is an important measurement of network startup and recovery delay. Providing a test tool that can measure IP address assignment convergence delay is useful in characterizing both startup delay of a DUT and recovery of the DUT after a failure. Using the test tool to transmit a burst of traffic after IP address assignment can also test the scalability, performance, and stability of the DUT during the IP address assignment convergence period.

The foregoing description is for the purpose of illustration only, and not for the purpose of limitation, as the subject matter described herein is defined by the claims as set forth hereinafter.

What is claimed is:

1. A method for determining Internet protocol (IP) address assignment convergence time of a device under test (DUT), the method comprising:
operating, by a test tool, as a dynamic host configuration protocol (DHCP) server;
receiving, by the test tool and from the DUT, a request for IP address assignment;
reserving, by the test tool, an IP address to be assigned to the DUT;
transmitting, by the test tool and using DHCP, the IP address to the DUT;
assigning, by the test tool, the IP address to the DUT;
recording, by the test tool, a time value T1 associated with assigning the IP address to the DUT;
transmitting, by the test tool and to the DUT, a plurality of IP packets;
receiving, by the test tool and from the DUT, one of the IP packets;
recording, by the test tool, a time value T2 of receipt of the one IP packet;
calculating, by the test tool, an IP address assignment convergence time of the DUT as a difference between T2 and T1; and
displaying or otherwise communicating, by the test tool, the IP address assignment convergence time of the DUT.

2. The method of claim 1 wherein operating as a DHCP server includes operating a control plane engine on a first port of the test tool as the DHCP server.

3. The method of claim 1 wherein receiving the request for IP address assignment includes receiving a DHCP DISCOVER message from the DUT.

4. The method of claim 1 wherein transmitting the IP address to the DUT includes transmitting the IP address to the DUT in a DHCP OFFER message.

5. The method of claim 4 comprising receiving, from the DUT, a DHCP REQUEST message requesting assignment of the IP address and assigning the IP address to the DUT includes assigning the IP address to the DUT in response to the DHCP REQUEST message and transmitting a DHCP acknowledgement (ACK) message to the DUT DUT confirming assignment of the IP address to the DUT.

6. The method of claim 5 wherein recording the time value T1 associated with assigning the IP address to the DUT includes recording a time of transmitting the DHCP ACK message the DUT confirming assignment of the IP address to the DUT.

7. The method of claim 2 wherein transmitting the plurality of IP packets to the DUT includes transmitting the IP packets from a data plane traffic engine operating on the first port of the test tool.

8. The method of claim 7 wherein receiving one of the IP packets from the DUT includes receiving the one IP packet by a data plane traffic engine operating on a second port of the test tool and recording the time value T2 associated with receipt of the one IP packet includes recording the value T2 by the data plane traffic engine operating on the second port of the test tool.

9. The method of claim 8 comprising subscribing, by the data plane traffic engine operating on the first port of the test tool and with the control plane engine, to be notified when the DHCP server assigns the IP address to the DUT, receiving, by the data plane traffic engine operating on the first port of the test tool, notification of assignment of the IP address to the DUT and wherein transmitting the IP packets to the DUT includes transmitting the IP packets to the DUT after receiving the notification.

10. The method of claim 2 wherein the control plane engine operating on the first port of the test tool inserts the time value T1 in a payload of each of the IP packets transmitted to the DUT and wherein calculating the IP address assignment convergence time includes reading the time value T1 from the payload of the one IP packet.

11. A system for determining Internet protocol (IP) address assignment convergence time of a device under test (DUT), the system comprising:
a test tool including at least one processor and a memory;
a dynamic host configuration protocol (DHCP) server executable by the at least one processor for receiving, from the DUT, a request for IP address assignment, reserving, an IP address to be assigned to the DUT, transmitting, using DHCP, the IP address to the DUT, assigning the IP address to the DUT, and recording a time value T1 associated with assigning the IP address to the DUT;
a traffic source endpoint implemented by the test tool for transmitting a plurality of IP packets to the DUT;
a traffic destination endpoint implemented by the test tool for receiving one of the IP packets from the DUT; and
an IP address assignment convergence time calculation module implemented by the test tool for recording a time value T2 associated with receipt of the one IP packet, calculating an IP address assignment convergence time of the DUT a difference between T2 and T1, and displaying or otherwise communicating the IP address assignment convergence time of the DUT.

12. The system of claim 11 wherein the test tool includes a control plane engine operating on a first port of the test tool and the DHCP server is implemented by the control plane engine.

13. The system of claim 11 wherein the DHCP server is configured to transmit the IP address to the DUT in a DHCP OFFER message.

14. The system of claim 13 wherein the DHCP server is configured to receive, from the DUT, a DHCP REQUEST message requesting assignment of the IP address, assign the IP address to the DUT in response to the DHCP REQUEST message and transmit a DHCP acknowledgement (ACK) message to the DUT confirming assignment of the IP address to the DUT.

15. The system of claim 14 wherein the DHCP server is configured to record, as the time value T1, a time of transmitting the DHCP ACK message the DUT.

16. The system of claim 12 wherein the test tool comprises a data plane traffic engine operating on the first port of the test tool, the data plane traffic engine operating on the first port of the test tool implements the traffic source endpoint and transmits the IP packets to the DUT.

17. The system of claim 16 wherein the test tool includes a data plane traffic engine operating on a second port of the test tool that implements the traffic source endpoint, receives the one IP packet, and records the time value T2.

18. The system of claim 17 wherein the data plane traffic engine operating on the first port of the test tool is configured to subscribe with the control plane engine to be notified when the DHCP server assigns the IP address to the DUT, receive notification of assignment of the IP address to the DUT and transmit the IP packets to the DUT after receiving the notification.

19. The method of claim 2 wherein the control plane engine operating on the first port of the test tool is configured to insert the time value T1 in a payload of each of the IP packets transmitted to the DUT and the IP address assignment convergence time calculation module is configured to calculate the IP address assignment convergence time by reading the time value T1 from the payload of the one IP packet.

20. A non-transitory computer readable medium having stored thereon executable instructions that when executed by a processor of a computer controls the computer to perform steps comprising:
operating, by a test tool, as a dynamic host configuration protocol (DHCP) server;
receiving, by the test tool and from a device under test (DUT), a request for Internet protocol (IP) address assignment;
reserving, by the test tool, an IP address to be assigned to the DUT;
transmitting, by the test tool and using DHCP, the IP address to the DUT;
assigning, by the test tool, the IP address to the DUT;
recording, by the test tool, a time value T1 associated with assigning the IP address to the DUT;
transmitting, by the test tool and to the DUT, a plurality of IP packets;
receiving, by the test tool and from the DUT, one of the IP packets;
recording, by the test tool, a time value T2 of receipt of the one IP packet;
calculating, by the test tool, an IP address assignment convergence time of the DUT a difference between T2 and T1; and
displaying or otherwise communicating, by the test tool, the IP address assignment convergence time of the DUT.
